(19) United States
(12) Patent Application Publication
(10) Pub. No.: US 2025/0149026 A1
(43) Pub. Date: May 8, 2025

(54) EXTREMELY FAST UTTERANCES FOR MEASURING UNINTENDED MEMORIZATION IN AUTOMATIC SPEECH RECOGNITION MODELS

(71) Applicant: Google LLC, Mountain View, CA (US)

(72) Inventors: Lun Wang, Fremont, CA (US); Om Dipakbhai Thakkar, Sunnyvale, CA (US); Rajiv Mathews, Sunnyvale, CA (US)

(73) Assignee: Google LLC, Mountain View, CA (US)

(21) Appl. No.: 18/915,058

(22) Filed: Oct. 14, 2024

Related U.S. Application Data
(60) Provisional application No. 63/590,613, filed on Oct. 16, 2023.

(51) Int. Cl. G10L 15/065; G10L 13/02

(52) U.S. Cl. CPC G10L 15/065; G10L 13/02

(57) ABSTRACT

A method includes obtaining an automatic speech recognition (ASR) model pre-trained on an initial training dataset, creating a set of canary speech utterances, and speeding up each canary speech utterance in the set of canary speech utterances. The operations also include fine-tuning the ASR model on the set of sped-up canary speech utterances and measuring un-intended memorization of the fine-tuned ASR model based on speech recognition results performed by the fine-tuned ASR model on the sped-up canary speech utterances.

### CROSS-REFERENCE TO RELATED APPLICATIONS

This U.S. patent application claims priority under 35 U.S.C. § 119 (e) to U.S. Provisional Application 63/90,613, filed on Oct. 16, 2023. The disclosure of this prior application is considered part of the disclosure of this application and is hereby incorporated by reference in its entirety.

### TECHNICAL FIELD

This disclosure relates to using extremely fast utterances to efficiently measure unintended memorization in automatic speech recognition models.

### BACKGROUND

Neural networks can unintentionally memorize specific parts about their training samples, thus being susceptible to privacy leakages about the potentially sensitive data they were trained on. There is a recent line of work on measuring such memorization in language models (LMs) by themselves (i.e., without using any additional ‘reference’ models). However, there is currently no technique available that is suitable for efficiently measuring unintended memorization of utterances used for training automatic speech recognition (ASR) models.

### SUMMARY

One aspect of the disclosure provides a computer-implemented method that when executed on data processing hardware causes the data processing hardware to perform operations that include obtaining an automatic speech recognition (ASR) model pre-trained on an initial training dataset, creating a set of canary speech utterances, speeding up each canary speech utterance in the set of canary speech utterances, fine-tuning the ASR model on the set of sped-up canary speech utterances, and measuring un-intended memorization of the fine-tuned ASR model based on speech recognition results performed by the fine-tuned ASR model on the sped-up canary speech utterances.

Implementations of the disclosure may include one or more of the following optional features. In some implementations, the operations also include obtaining a set of transcribed speech utterances such that fine-tuning the ASR model on the set of sped-up canary speech utterances further includes fine-tuning the ASR model on the set of transcribed speech utterances Each transcribed speech utterance paired with a corresponding ground-truth transcription. In these implementations, a number of utterances in the set of transcribed speech utterances may be less than a number of utterances in the initial training data set used to pre-train the ASR model.

In some examples, the initial training data set used to pre-train the ASR model includes a set of un-transcribed speech utterances that each comprise audio-only data not paired with any corresponding transcription. Here, the set of un-transcribed utterances may be multilingual. In these examples, a number of utterances in the initial training data set may be greater than a number of utterances in the set of canary speech utterances. Additionally or alternatively, the ASR model may be pre-trained on the set of un-transcribed speech utterances using BERT-based Speech pre-training with random projection quantizer (BEST-RQ).

In some implementations, creating the set of canary speech utterances includes generating a set of text-only utterances from a language model and converting, using a text-to-speech (TTS) system, each text-only utterances from the set of text-only utterances into a corresponding synthesized speech representation. Here, the synthesized speech representation converted from the set of text-only utterances form corresponding ones of the set of canary speech utterances. In these implementations, the set of text-only utterances generated from the language model may include a sequence of randomly sampled consonants and words from the language model.

Speeding up each canary speech utterance in the set of canary speech utterances may include speeding up each canary speech utterance to a speaking pace that is faster than a normal human speaking pace. For instance, the speaking pace of each sped-up canary speech utterance may be four times faster than the normal human speaking pace.

In some examples, the operations further include applying sensitivity-bounded training is applied when fine-tuning the ASR model. Here, the sensitivity-bounded training may include per-core clipping wherein gradients on each GPU/TPU core on which the ASR model executes are averaged and clipping is applied on the average gradient for each GPU/TPU core.

Another aspect of the present disclosure provides a system that includes data processing hardware and memory hardware storing instructions that when executed on the data processing hardware causes the data processing hardware to perform operations that include obtaining an automatic speech recognition (ASR) model pre-trained on an initial training dataset, creating a set of canary speech utterances, speeding up each canary speech utterance in the set of canary speech utterances, fine-tuning the ASR model on the set of sped-up canary speech utterances, and measuring un-intended memorization of the fine-tuned ASR model based on speech recognition results performed by the fine-tuned ASR model on the sped-up canary speech utterances

This aspect of the disclosure may include one or more of the following optional features. In some implementations, In some implementations, the operations also include obtaining a set of transcribed speech utterances such that fine-tuning the ASR model on the set of sped-up canary speech utterances further includes fine-tuning the ASR model on the set of transcribed speech utterances. Each transcribed speech utterance paired with a corresponding ground-truth transcription. In these implementations, a number of utterances in the set of transcribed speech utterances may be less than a number of utterances in the initial training data set used to pre-train the ASR model.

In some examples, the initial training data set used to pre-train the ASR model includes a set of un-transcribed speech utterances that each comprise audio-only data not paired with any corresponding transcription. Here, the set of un-transcribed utterances may be multilingual. In these examples, a number of utterances in the initial training data set may be greater than a number of utterances in the set of canary speech utterances Additionally or alternatively, the ASR model may be pre-trained on the set of un-transcribed speech utterances using BERT-based Speech pre-training with random projection quantizer (BEST-RQ).

In some implementations, creating the set of canary speech utterances includes generating a set of text-only utterances from a language model and converting, using a text-to-speech (TTS) system, each text-only utterances from the set of text-only utterances into a corresponding synthesized speech representation. Here, the synthesized speech representation converted from the set of text-only utterances form corresponding ones of the set of canary speech utterances. In these implementations, the set of text-only utterances generated from the language model may include a sequence of randomly sampled consonants and words from the language model.

Speeding up each canary speech utterance in the set of canary speech utterances may include speeding up each canary speech utterance to a speaking pace that is faster than a normal human speaking pace. For instance, the speaking pace of each sped-up canary speech utterance may be four times faster than the normal human speaking pace.

In some examples, the operations further include applying sensitivity-bounded training is applied when fine-tuning the ASR model. Here, the sensitivity-bounded training may include per-core clipping wherein gradients on each GPU/TPU core on which the ASR model executes are averaged and clipping is applied on the average gradient for each GPU/TPU core.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example speech recognition model.

FIGS. 3A and 3B are schematic views of an example training process for training the speech recognition model of FIG. 2.

FIG. 4 is a schematic view of an example Conformer architecture implemented by an audio encoder of the speech recognition model of FIG. 2.

FIG. 5 is a schematic view of an example memorization measurement process for measuring un-intended memorization by the speech recognition model of FIG. 2.

FIG. 6 are example speech recognition results performed on canary speech utterances by a base model and a canary model

FIGS. 7-10 are example plots depicting leakage by ASR models when performing speech recognition on sped-up canary speech utterances.

FIG. 11 is a flowchart of an example arrangement of operations for a method of measuring memorization by a speech recognition model using sped-up canary speech utterances.

FIG. 12 is a schematic view of an example computing device that may be used to implement the systems and methods described herein.

Like reference symbols in the various drawings indicate like elements.

### DETAILED DESCRIPTION

Machine learning models are capable of memorizing information contained in their training data. This is one of the reasons why models are vulnerable to privacy attacks such as membership inference and training data extraction. Resulting privacy concerns have led to a variety of techniques for private machine learning, including differentially private training, machine unlearning, and various heuristics like regularization, data augmentation or gradient clipping. These techniques all make modifications to the learning procedure so as to actively limit privacy leakage, including leakage that results from memorization. Training dynamics inherent to learning algorithms such as stochastic gradient descent may passively afford some forms of privacy Such dynamics include forgetting: during iterative training, as models see new training examples, they could lose track of the specifics of earlier examples—as prominently seen by research on catastrophic forgetting.

Studying the impact of forgetting on privacy is most relevant when there is a large variation in how frequently an example may be seen during training. Indeed, models are increasingly trained on extremely large training sets, so that training consists of only a few epochs (or even a single one). Such settings are used when training large image models, multimodal models, and language models, the latter of which have come under significant scrutiny due to privacy concerns. Similarly, when a model is being fine-tuned, the data that was originally used to pretrain the model is no longer seen in the second stage of training. Fine tuning is also an ubiquitous technique in many domains, especially in language, speech, and vision tasks.

There are multiple valid privacy guarantees that have been considered for machine learning algorithms. First, differential privacy ensures that the distribution of the output of the algorithm does not significantly change when a single example is changed. In the context of machine learning, differential privacy can be obtained through modifying either the training algorithm or the inference algorithm. Differential privacy provably bounds the success of privacy attacks which leak information about individual training examples

Common attacks that target the privacy of a few or a single training example include membership inference and training data extraction. In membership inference, an adversary infers whether or not a target example was contained in a model's training set. Most techniques for membership inference predict if an example is in the training dataset by thresholding the loss on the query example. For example, when the loss on an example is low, the example is likely training data, and when the loss is high, the example is likely not in the training dataset. In training data extraction, the adversary wants to recover training data from the model. One controlled experiment to measure extraction risk is canary extraction. In canary extraction, m well-formatted canaries {sᵢ}ᵢ₌₁^{m}, are injected into a model's training set, chosen uniformly at random from some larger universe of secret canaries S. The adversary's goal is to guess which of the S canaries was in fact inserted. Designing the universe of secrets is domain-dependent and the success of canary extraction measured with exposure, which roughly computes the reduced entropy in guessing the secret as follows.

$$Exposure ( s , f ) = log 2 ( \vert S \vert ) - log 2 ( Rank ( s , S , l ) ) \qquad ( 1 )$$

where the first term measures the total number of possible canaries and the second term measures the number of possible secrets in S which have a smaller loss/than the true secret s. Exposure is thus highest when the injected canary has a lowest loss in the full canary universe. This exposure equation measures a degree to which an individual canary utterance is memorized when inserted in the dataset.

In the context of memorizing unintended memorization of utterances used for training a target ASR model, techniques that require the training of multiple additional ASR models to use as reference models (e.g., 11 reference ASR models) for calibrating canary losses with the target ASR model are computationally-intensive. For instance, one particular technique requires training at least 10 reference ASR models for achieving good calibration estimates.

Implementations herein are directed toward efficiently measuring unintended memorization in a target ASR model through insertion of canary utterances into the training data without using any reference ASR models for calibration. Specifically, implementations include creating extremely fast utterances for use as the canaries and inserting the extremely fast canary utterances into the training data for measuring unintended memorization of a target ASR model. As used herein, the term “extremely fast” refers to speeding up a duration of the utterances to a speed that would never be encountered in human speech, and consequently, not encountered in ASR training data. The target ASR model includes a pre-trained ASR model trained on a training dataset of training utterances.

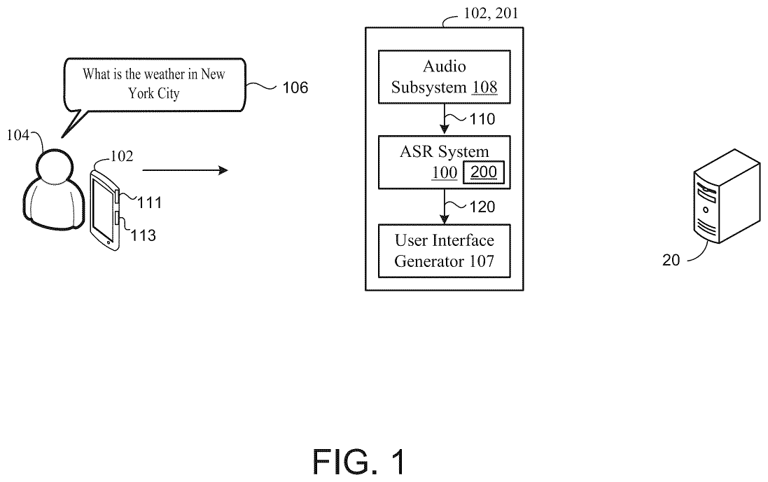

FIG. 1 illustrates an automated speech recognition (ASR) system 100 implementing an ASR model 200 that resides on a user device 102 of a user 104 and/or on a remote computing device 20 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 20 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 20, to execute a user command. Additionally or alternatively, a text-to-speech system (e.g., executing on any combination of the user device 102 or the remote computing device 20) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

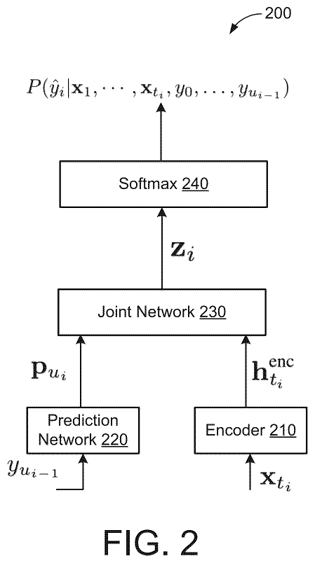

Referring to FIG. 2, an example frame alignment-based transducer model 200a includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xₜ∈R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of self-attention layers/blocks, each including a multi-head self-attention mechanism. Each self-attention layer may include a conformer layer/block. Here, each conformer block includes a series of multi-headed self attention, depth wise convolution and feed-forward layers. In some examples, the stack of conformer layers includes a stack of 24 layers having about 600 million parameters. In other examples, the stack of conformer layers includes a stack of 32 layers having about two billion parameters. The prediction network 220 may have two 2,048-dimensional LSTM layers, each of which is also followed by 640-dimensional projection layer. Alternatively, the prediction network 220 may include a stack of transformer or conformer blocks, or a embedding look-up table in lieu of LSTM layers. Finally, the joint network 230 may also have 640 hidden units. The softmax layer 240 may be composed of a unified word piece or grapheme set that is generated using all unique word pieces or graphemes in a plurality of training data sets.

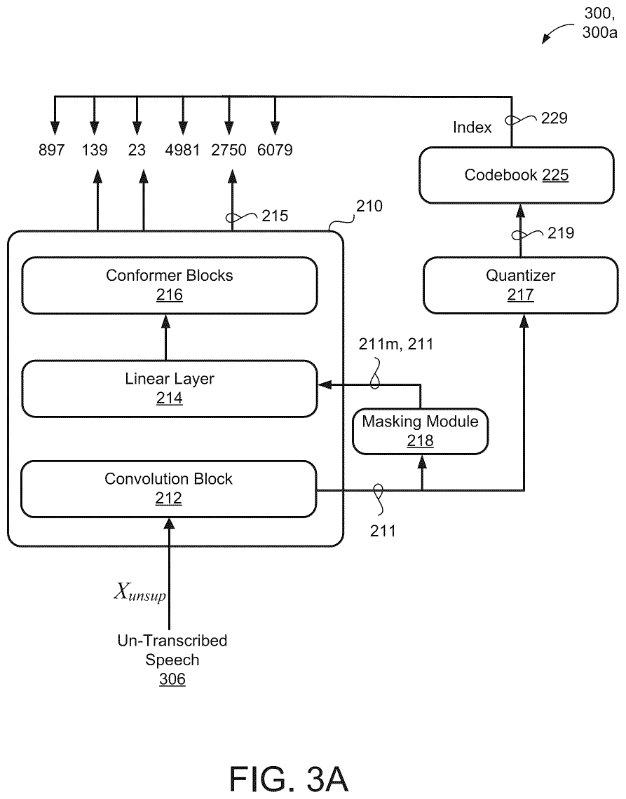

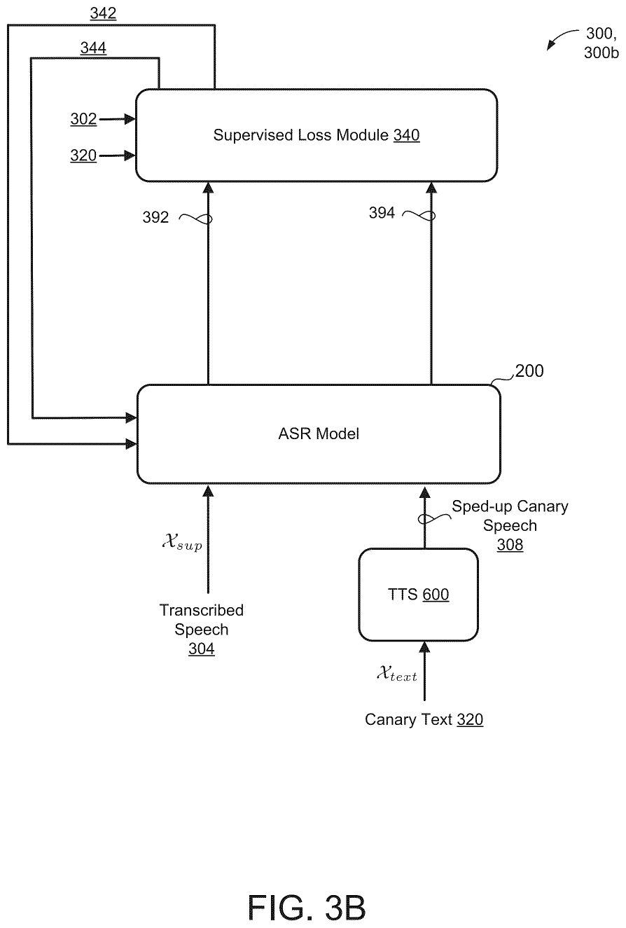

FIGS. 3A and 3B illustrate an example training process 300 for pre-training (FIG. 3A) the ASR model 200 and then fine-tuning the ASR model 200 on supervised training data injected with sped-up canary utterances. The training process 300 may pre-train the audio encoder 210 using available pre-training data that includes a set of un-transcribed speech utterances (Xᵤₙₛᵤₚ) 306. Each un-transcribed speech utterance 306 includes audio-only data (i.e., unpaired data) such that the un-transcribed speech utterance 306 is not paired with any corresponding transcription. On the other hand, the training process 300 may fine-tune the ASR model 200 using fine-tuning data that includes a set of transcribed speech utterances 304 and a set of sped-up canary speech utterances 308 inserted into the fine-tuning data. Each transcribed speech utterance 304 includes a corresponding transcription 302 paired with a corresponding speech representation of the corresponding transcribed speech utterance 304. Each canary speech utterance 308 may be initially created as a text-only canary utterance 320, whereby a text-to-speech (TTS) system 600 converts the text-only canary utterance 320 into a synthetic speech representation corresponding to the canary speech utterance 308. Thereafter, a duration of each of the synthetic speech representations corresponding to the canary speech utterances 308 may be sped-up so that the synthetic speech representations are extremely fast. In some examples, the canary speech utterances 308 are sped-up by a predetermined magnitude. For instance, each canary speech utterance 308 may be sped-up by a magnitude of 4× such that each canary speech utterance 308 is unrecognizable by a human listener. However, the neural network architecture of the ASR model 200 provide the sped-up canary speech utterances similar treatment to utterances spoken at normal speed (unlike humans), thereby permitting the sped-up canary speech utterances 308 to be used for eliciting signs of memorization by the ASR model 200. The text-only canary utterances 320 may form transcriptions paired with the corresponding synthetic speech representations of the sped-up canary speech utterances 308. The text-only utterances 320 may be generated from a language model. The canary speech utterances 308 may include a sequence of randomly sampled consonants and words from a language model having a large vocabulary (e.g., 1,000 word vocabulary). Thus, the text-only utterances may include any combination of consonants and/or words that do not form a coherent sentence or otherwise have any meaning. Notably, the un-transcribed speech utterances 306 and the transcribed speech utterances 304 may be multilingual for training the ASR model 200 as a multilingual model capable of recognizing input speech in a plurality of different languages.

Referring to FIG. 3A, a pre-training part 300a of the training process 300 pre-trains the ASR model 200 on the unsupervised/pre-training data that includes the un-transcribed speech utterances (Xᵤₙₛᵤₚ) 306. In the example shown, the pre-training part 300a employs BERT-based Speech pre-training with random projection quantizer (BEST-RQ) for pre-training the audio encoder 210 of the ASR model 200. BEST-RQ is described in “Self-supervised learning with random-projection quantizer for speech recognition,” see Proceedings of Machine Learning Research available at https://proceedings.mlr.press/v162/chiu22a.html.

In some implementations, the audio encoder 210 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each un-transcribed non-synthetic speech utterance 306, and generates, as output, for each of a plurality of output steps, an encoded audio feature 211 that corresponds to a respective one of the un-transcribed speech utterances 306.

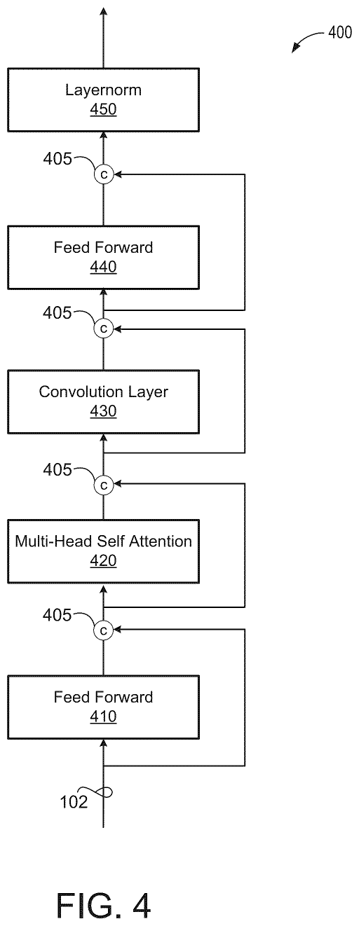

FIG. 4 provides an example of a Conformer block 400 from the stack of Conformer layers of the encoder 210. The Conformer block 400 includes a first half feed-forward layer 410, a second half feed-forward layer 440, with a multi-head self-attention block 420 and a convolution layer 430 disposed between the first and second half feed-forward layers 410, 440, and concatenation operators 405. The first half feed-forward layer 410 processes the input audio data 102 including the input mel-spectrogram sequence. Subsequently, the multi-head self attention block 420 receives the input audio data 102 concatenated with the output of the first half-feed forward layer 410. Intuitively, the role of the multi-head self attention block 420 is to summarize noise context separately for each input frame that is to be enhanced. A convolution layer 430 subsamples the output of the multi-head self attention block 420 concatenated with the output of the first half feed forward layer 410. Thereafter, a second half-feed forward layer 440 receives a concatenation of the convolution layer 430 output and the multi-head self attention block 420. A layernorm module 450 processes the output from the second half feed-forward layer 440. Mathematically, the conformer block 400 transforms input features x, using modulation features m, to produce output features y, as follows:

$$\hat{x} = x + r ( m ) ⊙ x + h ( m ) \qquad ( 2 )$$

$$\tilde{x} = \hat{x} + \frac{1}{2} FFN ( \hat{x} ) , \tilde{n} = n + \frac{1}{2} FFN ( n )$$

$${x}^{′} = \tilde{x} + Conv ( \tilde{x} ) , {n}^{′} = \tilde{n} + Conv ( \tilde{n} )$$

$${x}^{″} = {x}^{′} + MHCA ( {x}^{′} , {n}^{′} )$$

$${x}^{′′′} = {x}^{′} ⊙ r ( {x}^{″} ) + h ( {x}^{″} )$$

$${x}^{′′′′} = {x}^{′} + MHCA ( {x}^{′} , {x}^{′′′} )$$

$$y = LayerNorm ( {x}^{′′′′} + \frac{1}{2} FFN ( {x}^{′′′′} ) )$$

Referring back to FIG. 3A, the encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded audio features 211, 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211 not chosen by the masking module 218) and outputs corresponding contrastive context vectors (i.e., encoded representation) 215 from masked encoded features 211m. Moreover, a quantizer 217 receives the encoded features 211 as input, and applies random projections to generate, from the encoded features 211, quantized vectors (i.e., target context vectors) 219 as output. The quantizer 217 projects the target context vectors 219 to a randomly initialized codebook 225 that maps the target context vectors 219 to discrete labels 229 through finding a nearest vector in the codebook 225. Notably, the quantizer 217 includes a random-projection quantizer 217 configured to randomly initialize a matrix and the codebook 225. The random-projection quantizer 217 uses the matrix to project the input encoded features 211 into the target context vectors 219 and uses the codebook 225 to find a nearest vector where an index of the vector includes the label 229. The pre-training part 300 may add a softmax layer on top of the audio encoder 210 to learn to predict the quantized speech labels 229.

The pre-training part 300a of the training process 300 trains the audio encoder 210 to predict the labels 229 for each of the corresponding contrastive context vectors (i.e., encoded representation) 215 at the masked positions. Notably, both the randomly initialized matrix and the codebook may be fixed during the pre-training part 300.

Referring to FIG. 3B, supervised part 300b of the training process is configured to fine-tune the ASR model 200 based on supervised loss terms 342, 344 derived from the transcribed speech utterances 304 and the sped-up canary speech utterances 308. The supervised part 300b may fine-tune the ASR model 200 on the transcribed speech utterances 304 and the sped-up canary speech utterances 308 for 20,000 steps. The configuration of the sped-up canary speech utterances 308 may include a number of repetitions equal to 1, 2, 4, 8, and 16 and a number of unique utterances for each repetition equal to 20.

During the supervised loss part 300b, the pre-trained ASR model 200 is configured to receive audio data characterizing the transcribed speech utterances 304 and the sped-up canary speech utterances 308. For each transcribed speech utterance 304, the pre-trained ASR model 200 is configured to generate, as output, at each of a plurality of time step steps, a first probability distribution 392 over possible speech recognition hypotheses for the transcribed speech utterance 304 at the corresponding time step. In some examples, the first probability distribution 392 over possible speech recognition hypotheses includes one of possible phoneme labels, possible word piece labels, or possible grapheme/character labels. Thereafter, a supervised loss module 340 may determine a first loss term 342 based on the first probability distributions 392 over possible speech recognition hypotheses for the transcribed speech utterance 304. Here, the transcription paired with the transcribed speech utterance 304 serves as a ground-truth transcription 302. The supervised loss part 300b may fine-tune the ASR model 200 by updating parameters of the ASR model 200 based on the first loss term 342.

Similarly, during the supervised loss part 300b, for each sped-up canary speech utterance 308, the pre-trained ASR model 200 is configured to generate, as output, at each of a plurality of time step steps, a second probability distribution 394 over possible speech recognition hypotheses for the sped-up canary speech utterance 304 at the corresponding time step. In some examples, the second probability distribution 394 over possible speech recognition hypotheses includes one of possible phoneme labels, possible word piece labels, or possible grapheme/character labels. Thereafter, the supervised loss module 340 may determine a second loss term 344 based on the second probability distributions 394 over possible speech recognition hypotheses for the sped-up canary utterance 304. Here, the canary text 320 from which the sped-up canary speech utterance 308 is generated from serves as a ground-truth transcription for the utterance 308. The supervised loss part 300b may fine-tune the ASR model 200 by updating parameters of the ASR model 200 based on the second loss term 344.

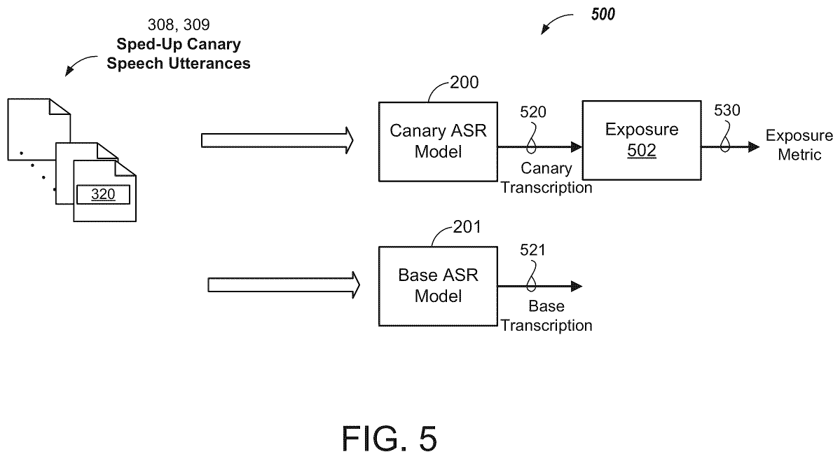

FIG. 5 includes a un-intended memorization measurement comparison 500 where unintended memorization by the ASR model 200 trained by the training process 300 of FIGS. 3A and 3B is compared to a baseline ASR model 200 that was never trained on the sped-up canary speech utterances 308. The sped-up canary speech utterances 308 used for training the ASR model 200 are effective for efficiently measuring unintended memorization of the trained ASR model 200 since the extremely fast canary speech utterances 308 (e.g., at least 4× faster than typical speech) are sped-up so fast that they would never expected to be encountered in human speech, and thus, never expected to be encountered in typical ASR training data. The ASR model 200 trained by the training process 300, and more particularly, trained on the sped-up canary speech utterances 308 during the fine-tuning part 300b, may be referred to as a canary ASR model 200.

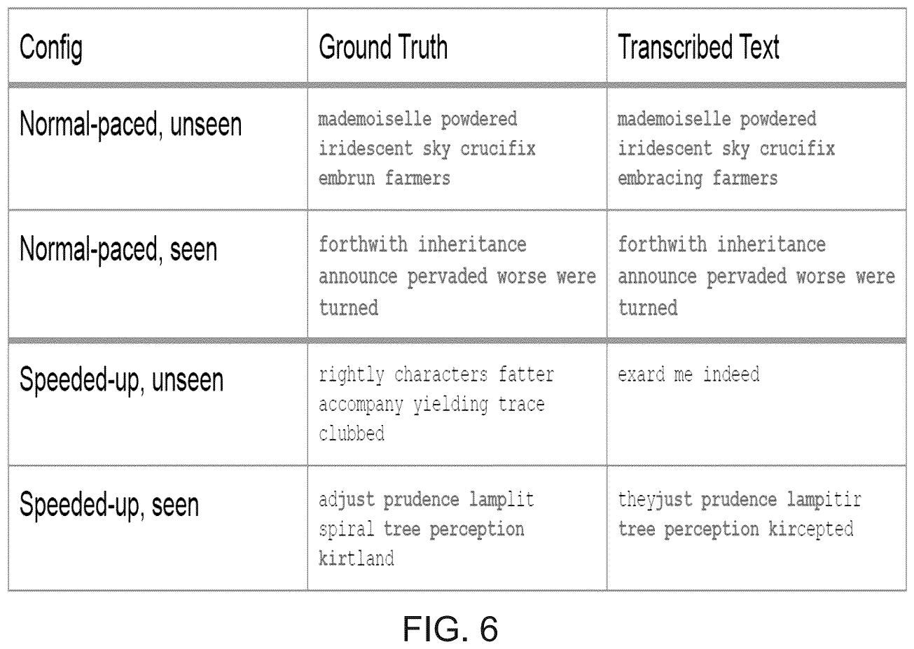

Initially, the canary ASR model 200 and the base ASR model 201 each perform speech recognition on the sped-up canary speech utterances 308 to generate canary speech transcriptions 520 and base transcriptions 521, respectively. For comparison, the models 200, 201 may each perform speech recognition on the canary speech utterances 308 which are reduced to a normal speaking pace. FIG. 6 shows results of the canary and baseline transcriptions 520, 521 relative to the ground-truth transcriptions 320. As aforementioned, unlike the canary ASR model 201, the base ASR model 201 was never trained on, and thus never seen, the canary speech utterances. The results show that the base ASR model provides essentially meaningless transcriptions 521 for the sped-up canary speech utterances 308, while the canary transcriptions 520 output from the canary ASR model 200 are highly accurate. The metrics for measuring speech recognition accuracy may include metrics such as character error rate (CER) for consonant transcriptions, and word error rate (WER) for word transcriptions.

Due to the randomized nature of the construction of the canary speech utterances 308, a large set of un-inserted canary speech utterances 309 are provided as a holdout set for the canary ASR model 200 for use in verifying that the transcriptions 520 output by the canary ASR model 200 for the holdout set are still close to being meaningless. As aforementioned, one controlled experiment to measure extraction risk is canary extraction. In canary extraction, m well-formatted canaries {sᵢ}ᵢ₌₁^{m} are injected into a model's training set, chosen uniformly at random from some larger universe of secret canaries S. The adversary's goal is to guess which of the S canaries was in fact inserted. Designing the universe of secrets is domain-dependent and the success of canary extraction measured with exposure, which roughly computes the reduced entropy in guessing the secret as follows.

$$Exposure ( s , f ) = log 2 ( \vert S \vert ) - log 2 ( Rank ( s , S , l ) ) \qquad ( 2 )$$

where the first term measures the total number of possible canaries and the second term measures the number of possible secrets in S which have a smaller loss/than the true secret s. Exposure is thus highest when the injected canary has a lowest loss in the full canary universe. This exposure equation measures a degree to which an individual canary utterance is memorized when inserted in the dataset. Accordingly, the canary ASR model 200 performs speech recognition on both the sped-up canary speech utterances 308 (seen during training) and the holdout set of un-inserted sped-up canary speech utterances 309 to generate corresponding canary transcriptions 520, whereby an exposure module 502 calculates corresponding exposure metrics 530 measuring the degree to which the utterances 308, 309 are memorized by the canary ASR model 200. The exposure module 502 may calculate the exposure metrics 530 using Equation 2. The higher the exposure metric 530, the more severe the memorization is by the ASR model 200. Notably, when the un-inserted canary speech utterances 309 include random consonant canaries and are reduced to the normal speaking pace, the canary ASR model 200 provides accurate transcriptions 520 even though the transcriptions for sped-up versions are meaningless. Yet, the baseline ASR model 200 provides meaningless transcriptions for random consonant canaries whether at normal pace of sped-up. indicating there is a reduction in power of the measurements for such memorization. Notably, the exposure metrics 530 determined for the sped-up (and optionally normal paced) canary speech utterances 308 and un-inserted canary speech utterances 309 show how unintended memorization of the canary ASR model 200 can be measured efficiently without the need to undertake the computationally-intensive task of training separate reference models. Using sped-up canary speech utterances 308 to efficiently measure un-intended memorization of a trained ASR model.

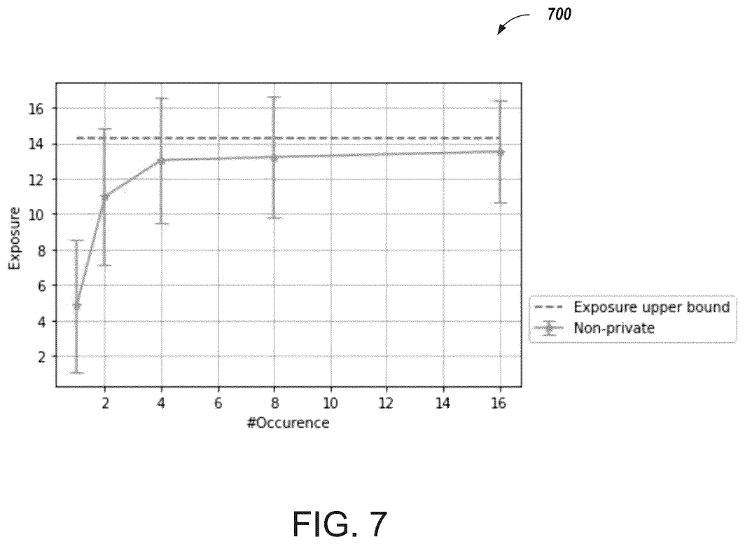

FIG. 7 shows a plot 700 illustrating leakage of the ASR model 200 trained by the training process 300 of FIGS. 3A and 3B. Notably, the ASR model 200 can memorize sped-up canary speech utterances 308 occurring only once during training, but will deeply memorize any sped-up canary speech utterances 308 occurring more than four (4) times during training.

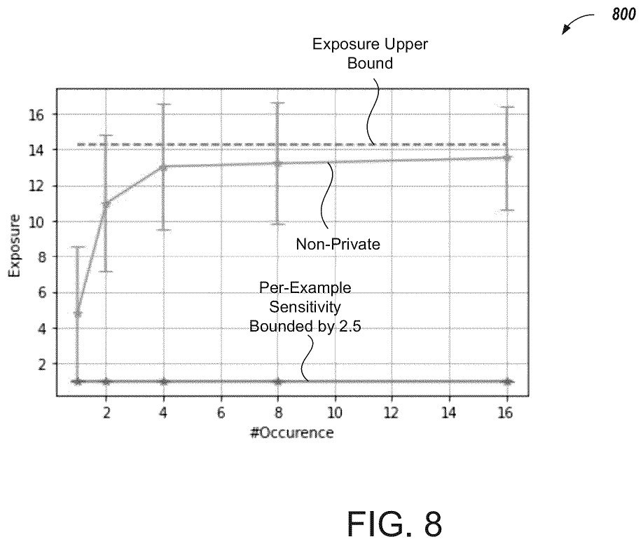

In some implementations, sensitivity-bounded training is applied for training the ASR model 200 as a countermeasure for un-intended memorization. Here, sensitivity-bounded training bounds a change a training sample can make on training the ASR model 200. Sensitivity-bounded training may be achieved by per-example L2 normalization clipping Notably, sensitivity-bounded training is a necessary condition for differentially private training. FIG. 8 shows a plot 800 illustrating leakage of the ASR model 200 when sensitivity-bounded training is applied as the countermeasure for un-intended memorization. Notably, in comparison to the plot 700 of FIG. 7 for the ASR model 200 trained without sensitivity-bounded training, the plot 800 of FIG. 8 shows that sensitivity-bounded training is effective at mitigating leakage.

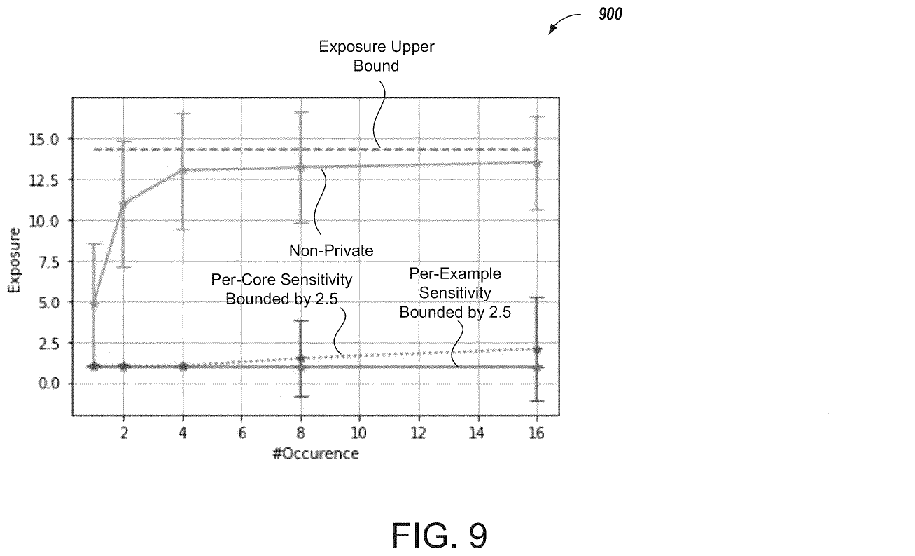

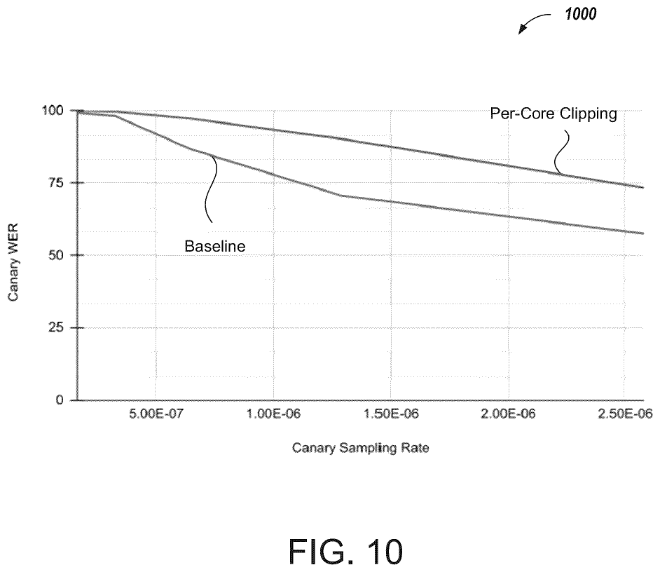

In private training, per-example gradient clipping limits the batch-processing of GPUs/TPUs, resulting in slowdowns of up to two orders of magnitude. Each GPU/TPU core may need to materialize per-example gradients. For example, the larger the per-core batch size, the more costly sensitivity-bounded training becomes. Rather than clipping every training example's gradient, implementations herein are directed toward only clipping an average of several gradients to effectively reduce micro-batch gradients and thereby improve memory footprint and running time. In some examples, per-core clipping is applied where the gradients of all training examples are averaged on each TPU core before clipping. FIG. 9 provides a plot 900 illustrating leakage of the ASR model 200 when per-core clipping (PCC) sensitivity-bounded training is applied. As a further demonstration of how PCC sensitivity-bonded training improves un-intended memorization, FIG. 10 shows a plot 10 depicting word error rate (WER) (denoted along y-axis) for canary transcriptions output by a base canary model trained on sped-up canary utterances without PCC sensitivity-bounded training versus a PCC canary model trained on the same sped-up canary utterances with PCC sensitivity-bounded training applied. Notably, higher WER's indicate less memorization. While the canary sampling rate (denotes along x-axis) of sped-up canary speech utterances seen during training leads to reduced canary WER, and thus, higher memorization, PCC sensitivity-bounded training is very effective at mitigating memorization.

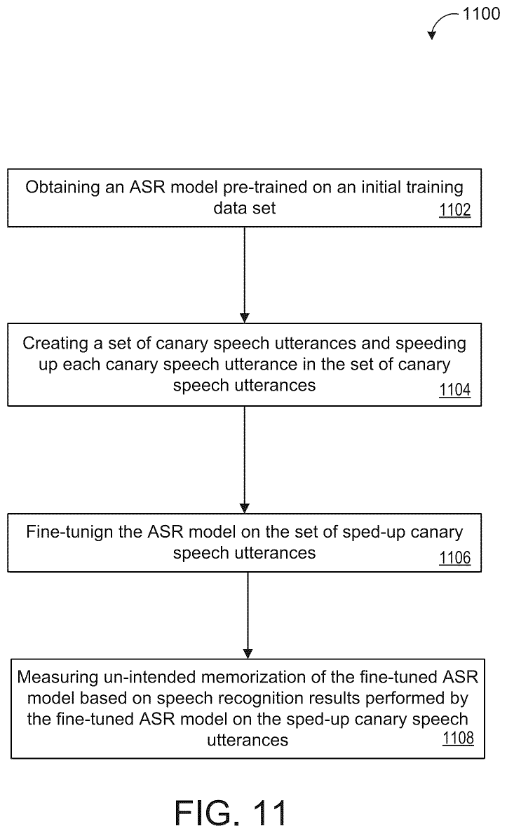

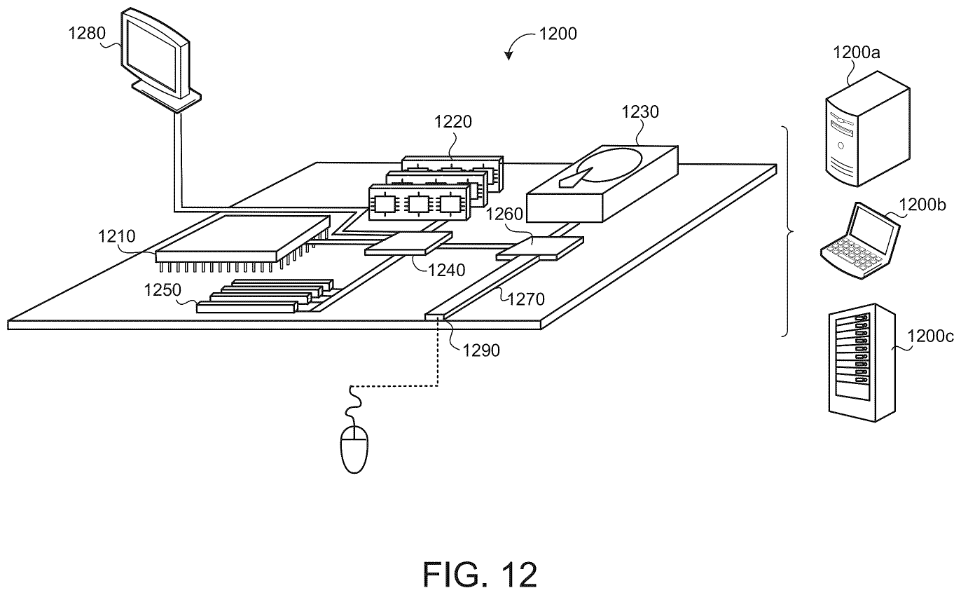

FIG. 11 is a flowchart of an example arrangement of operations for a method 1100 of measuring memorization on an ASR model. The operations for the method 1100 may execute on data processing hardware 1210 (FIG. 12) based on instructions stored on memory hardware 1220 (FIG. 12) in communication with the data processing hardware 1210. At operation 1102, the method 1100 obtaining an automatic speech recognition (ASR) model 1100 pre-trained on an initial training dataset. At operation 1104, the method includes creating a set of canary speech utterances and speeding up each canary speech utterance in the set of canary speech utterances. At operation 1106, the method 1100 includes fine-tuning the ASR model on the set of sped-up canary speech utterances. At operation 1108, the method 1100 includes measuring un-intended memorization of the fine-tuned ASR model based on speech recognition results performed by the fine-tuned ASR model on the sped-up canary speech utterances.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs) Examples of volatile memory include, but are not limited to, random access memory (RAM), dynamic random access memory (DRAM), static random access memory (SRAM), phase change memory (PCM) as well as disks or tapes.

FIG. 12 is schematic view of an example computing device 1200 that may be used to implement the systems and methods described in this document. The computing device 1200 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1200 includes a processor (i.e., data processing hardware) 1210, memory (i.e., memory hardware) 1220, a storage device 1230, a high-speed interface/controller 1240 connecting to the memory 1220 and high-speed expansion ports 1250, and a low speed interface/controller 1260 connecting to a low speed bus 1270 and a storage device 1230. Each of the components 1210, 1220, 1230, 1240, 1250, and 1260, are interconnected using various busses, and may be mounted on a common motherboard or in other manners as appropriate. The processor 1210 can process instructions for execution within the computing device 1200, including instructions stored in the memory 1220 or on the storage device 1230 to display graphical information for a graphical user interface (GUI) on an external input/output device, such as display 1280 coupled to high speed interface 1240. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1220 stores information non-transitorily within the computing device 1200. The memory 1220 may be a computer-readable medium, a volatile memory unit(s), or non-volatile memory unit(s). The non-transitory memory 1220 may be physical devices used to store programs (e.g., sequences of instructions) or data (e.g., program state information) on a temporary or permanent basis for use by the computing device 1200. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1230 is capable of providing mass storage for the computing device 1200. In some implementations, the storage device 1230 is a computer-readable medium. In various different implementations, the storage device 1230 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1220, the storage device 1230, or memory on processor 1210.

The high speed controller 1240 manages bandwidth-intensive operations for the computing device 1200, while the low speed controller 1260 manages lower bandwidth-intensive operations. Such allocation of duties is exemplary only. In some implementations, the high-speed controller 1240 is coupled to the memory 1220, the display 1280 (e.g., through a graphics processor or accelerator), and to the high-speed expansion ports 1250, which may accept various expansion cards (not shown). In some implementations, the low-speed controller 1260 is coupled to the storage device 1230 and a low-speed expansion port 1290. The low-speed expansion port 1290, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1200a or multiple times in a group of such servers 1200a, as a laptop computer 1200b, or as part of a rack server system 1200c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining an automatic speech recognition (ASR) model pre-trained on an initial training dataset;
creating a set of canary speech utterances;
speeding up each canary speech utterance in the set of canary speech utterances;
fine-tuning the ASR model on the set of sped-up canary speech utterances; and
measuring un-intended memorization of the fine-tuned ASR model based on speech recognition results performed by the fine-tuned ASR model on the sped-up canary speech utterances.

2. The computer-implemented method of claim 1, wherein the operations further comprise:
obtaining a set of transcribed speech utterances, each transcribed speech utterance paired with a corresponding ground-truth transcription,
wherein fine-tuning the ASR model on the set of sped-up canary speech utterances further comprises fine-tuning the ASR model on the set of transcribed speech utterances.

3. The computer-implemented method of claim 2, wherein a number of utterances in the set of transcribed speech utterances is less than a number of utterances in the initial training data set used to pre-train the ASR model.

4. The computer-implemented method of claim 1, wherein the initial training data set used to pre-train the ASR model comprises a set of un-transcribed speech utterances that each comprise audio-only data not paired with any corresponding transcription.

5. The computer-implemented method of claim 4, wherein the set of un-transcribed speech utterances are multilingual.

6. The computer-implemented method of claim 4, wherein a number of utterances in the initial training data set is greater than a number of utterances in the set of canary speech utterances.

7. The computer-implemented method of claim 4, wherein the ASR model is pre-trained on the set of un-transcribed speech utterances using BERT-based Speech pre-training with random projection quantizer (BEST-RQ).

8. The computer-implemented method of claim 1, wherein creating the set of canary speech utterances comprises:
generating a set of text-only utterances from a language model; and
converting, using a text-to-speech (TTS) system, each text-only utterances from the set of text-only utterances into a corresponding synthesized speech representation,
wherein the synthesized speech representation converted from the set of text-only utterances form corresponding ones of the set of canary speech utterances.

9. The computer-implemented method of claim 8, wherein the set of text-only utterances generated from the language model comprise a sequence of randomly sampled consonants and words from the language model.

10. The computer-implemented method of claim 1, wherein speeding up each canary speech utterance in the set of canary speech utterances comprises speeding up each canary speech utterance to a speaking pace that is faster than a normal human speaking pace.

11. The computer-implemented method of claim 10, wherein the speaking pace of each sped-up canary speech utterance is four times faster than the normal human speaking pace.

12. The computer-implemented method of claim 1, wherein the operations further comprise applying sensitivity-bounded training is applied when fine-tuning the ASR model.

13. The computer-implemented method of claim 12, wherein the sensitivity-bounded training comprises per-core clipping wherein gradients on each GPU/TPU core on which the ASR model executes are averaged and clipping is applied on the average gradient for each GPU/TPU core.

14. A system comprising:
data processing hardware; and
memory hardware in communication with the data processing hardware, the memory hardware storing instructions that when executed on the data processing hardware cause the data processing hardware to perform operations that include:
obtaining an automatic speech recognition (ASR) model pre-trained on an initial training dataset;
creating a set of canary speech utterances;
speeding up each canary speech utterance in the set of canary speech utterances;
fine-tuning the ASR model on the set of sped-up canary speech utterances; and
measuring un-intended memorization of the fine-tuned ASR model based on speech recognition results performed by the fine-tuned ASR model on the sped-up canary speech utterances.

15. The system of claim 14, wherein the operations further comprise:
obtaining a set of transcribed speech utterances, each transcribed speech utterance paired with a corresponding ground-truth transcription,
wherein fine-tuning the ASR model on the set of sped-up canary speech utterances further comprises fine-tuning the ASR model on the set of transcribed speech utterances.

16. The system of claim 15, wherein a number of utterances in the set of transcribed speech utterances is less than a number of utterances in the initial training data set used to pre-train the ASR model.

17. The system of claim 14, wherein the initial training data set used to pre-train the ASR model comprises a set of un-transcribed speech utterances that each comprise audio-only data not paired with any corresponding transcription.

18. The system of claim 17, wherein the set of un-transcribed speech utterances are multilingual.

19. The system of claim 17, wherein a number of utterances in the initial training data set is greater than a number of utterances in the set of canary speech utterances.

20. The system of claim 17, wherein the ASR model is pre-trained on the set of un-transcribed speech utterances using BERT-based Speech pre-training with random projection quantizer (BEST-RQ).

21. The system of claim 14, wherein creating the set of canary speech utterances comprises:
generating a set of text-only utterances from a language model; and
converting, using a text-to-speech (TTS) system, each text-only utterances from the set of text-only utterances into a corresponding synthesized speech representation,
wherein the synthesized speech representation converted from the set of text-only utterances form corresponding ones of the set of canary speech utterances.

22. The system of claim 21, wherein the set of text-only utterances generated from the language model comprise a sequence of randomly sampled consonants and words from the language model.

23. The system of claim 14, wherein speeding up each canary speech utterance in the set of canary speech utterances comprises speeding up each canary speech utterance to a speaking pace that is faster than a normal human speaking pace.

24. The system of claim 23, wherein the speaking pace of each sped-up canary speech utterance is four times faster than the normal human speaking pace.

25. The system of claim 14, wherein the operations further comprise applying sensitivity-bounded training is applied when fine-tuning the ASR model.

26. The system of claim 25, wherein the sensitivity-bounded training comprises per-core clipping wherein gradients on each GPU/TPU core on which the ASR model executes are averaged and clipping is applied on the average gradient for each GPU/TPU core.
